(19) United States
(12) Patent Application Publication
(10) Pub. No.: US 2020/0145676 A1
(43) Pub. Date: May 7, 2020

(54) ENCODING METHOD, DECODING METHOD, ENCODING APPARATUS AND DECODING APPARATUS

(71) Applicant: SZ DJI TECHNOLOGY CO., LTD., Shenzhen (CN)

(72) Inventors: Xiaozhen ZHENG, Shenzhen (CN); Liang YU, Shenzhen (CN)

(21) Appl. No.: 16/734,767

(22) Filed: Jan. 6, 2020

Related U.S. Application Data
(63) Continuation of application No. PCT/CN2017/099898, filed on Aug. 31, 2017.

(51) Int. Cl. H04N 19/182; H04N 19/167; H04N 19/105; H04N 19/184

(52) U.S. Cl. CPC H04N 19/182; H04N 19/184; H04N 19/105; H04N 19/167

(57) ABSTRACT

An encoding method and a decoding method are provided. An exemplary encoding method includes performing an encoding process on at least one pixel of a first rectangular region of an image; and if a total bit number Bi of encoded bits used by first i encoded pixels is smaller than or equal to a maximum bit number Bmax of allowable encoded bits and a sum of the total bit number Bi and a bit number bi+1 of encoded bits for use by an (i+1)-th pixel is greater than the maximum bit number Bmax, determining encoded data of at least one un-encoded pixel; and adding a first identifier on an encoded bitstream of the first rectangular region. The first identifier is configured to identify an end of the encoding process of the first rectangular region and identify that the first rectangular region includes the at least one un-encoded pixel.

### CROSS-REFERENCE TO RELATED APPLICATION

This application is a continuation of International Application No. PCT/CN2017/099898, filed Aug. 31, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of video encoding and, more particularly, to an encoding method, a decoding method, an encoding apparatus and a decoding apparatus.

### BACKGROUND

To reduce the bandwidth occupied by video storage and transmission, it is necessary to perform an encoding compression process on the video data. A typical video compression processing technique can be classified into two types: fixed length encoding and adaptive length encoding. Regardless of the encoding type, there may be an upper limit on the number of encoded bits allowed in pixels in the image. Sometimes, while the number of encoded bits currently used by the pixels may have reached the maximum number of encoded bits allowed for the pixels, there are still un-encoded pixels in the pixels. Thus, there is a need to process the boundary of the pixels.

### SUMMARY

One aspect of the present disclosure provides an encoding method. The encoding method includes performing an encoding process on at least one pixel of a first rectangular region of an image. The image includes at least one rectangular region, the at least one rectangular region includes the first rectangular region, and each of the at least one rectangular region includes at least one pixel. If a total bit number B of encoded bits used by first i encoded pixels in the first rectangular region is smaller than or equal to a maximum bit number Bₘₐₓ of allowable encoded bits in the first rectangular region and a sum of the total bit number Bᵢ and a bit number bᵢ₊₁ of encoded bits for use by an (i+1)-th pixel in the first rectangular region is greater than the maximum bit number Bₘₐₓ, encoded data of at least one un-encoded pixel in the first rectangular region is determined according to encoded data of at least one encoded pixel in the image. The at least one un-encoded pixel includes the (i+1)-th pixel, 1≤i≤T−1, and T is a total number of pixels included in the first rectangular region. A first identifier is added on an encoded bitstream of the first rectangular region. The first identifier is configured to identify an end of the encoding process of the first rectangular region and identify that the first rectangular region includes the at least one un-encoded pixel.

Another aspect of the present disclosure provides a decoding method. The decoding method includes, according to an encoded bitstream of an image, performing a decoding process on a first rectangular region of the image. The image includes at least one rectangular region, the at least one rectangular region includes the first rectangular region and each rectangular region includes at least one pixel. The decoding method also includes, according to decoded data of at least one decoded pixel in the image, determining, if the encoded bitstream image includes a first identifier, decoded data of at least one un-decoded pixel in the first rectangular region. The first identifier is used to indicate the end of the decoding process of the first rectangular region and indicate that the first region includes at least one un-decoded pixel.

### BRIEF DESCRIPTION OF THE DRAWINGS

FIG. 1 is a schematic flow chart of an encoding method according to an example embodiment of the present disclosure.

FIG. 2 is a schematic flow chart of a decoding method according to an example embodiment of the present disclosure.

FIG. 3 is a schematic block diagram of an encoding method according to an example embodiment of the present disclosure.

FIG. 4 is a schematic block diagram of a decoding method according to an example embodiment of the present disclosure.

FIG. 5 is a schematic block diagram of an encoding method according to another example embodiment of the present disclosure.

FIG. 6 is a schematic block diagram of a decoding method according to another example embodiment of the present disclosure.

### DETAILED DESCRIPTION OF THE EMBODIMENTS

Technical solutions of the present disclosure will be described with reference to the drawings.

The embodiments of the present disclosure may be applied to various codec systems, such as a codec system with a fixed compression ratio or a codec system with an adaptive compression ratio, which is not limited in this embodiment of the present disclosure.

In the embodiments of the present disclosure, the image may be divided into at least one rectangular area, and each rectangular area may include one or more pixels. A rectangular area may be referred to as a tile or other name, and is not limited by the present disclosure. If the image is divided into a plurality of rectangular regions, different rectangular regions of the image may have the same or different lengths. For example, at least one rectangular region spaced from the image boundary may have the same length. In one embodiment, the width of the rectangular region may be one pixel or a plurality of pixels and is not limited by the present disclosure.

For example, one image may be divided into a plurality of rectangular regions according to a first preset size, and rectangular regions not located at the image boundary may have the same size. Being limited by the size of the image, the size of the rectangular regions located at the boundary of the image may be determined by the first preset size and the image size; and may be the same as the size of other rectangular regions not located at the boundary of the image, or may be different from the size of other rectangular regions. For example, the image length may be assumed as 3840 pixels and the first preset size is 1056 pixels, the image can be divided into four rectangular regions in the order from left to right. The lengths of the first to third rectangular regions may be 1056 pixels, and the fourth rectangular region may be located at the image boundary. If the length of the fourth rectangular region is still 1056 pixels, the fourth rectangular region will exceed the image boundary. At this time, the length of the fourth rectangular region may be set as 672 pixels.

In one embodiment of the present disclosure, the number of the encoded bits allowed for the rectangular region may have an upper limit. For example, the numbers of encoded bits corresponding to the rectangular regions of the same length may be less than or equal to the preset number of bits

In particular, when the number of encoded bits is equal to a preset number of bits, the rectangular regions of the same length correspond to the same number of encoded bits. That is, the rectangular regions in the images may be encoded at a fixed magnification.

When the number of encoded bits is less than or equal to a preset number of bits, the compression ratio of the image corresponding to the rectangular regions may be greater than or equal to the compression ratio of the same number of encoded bits corresponding to the same number of encoded bits.

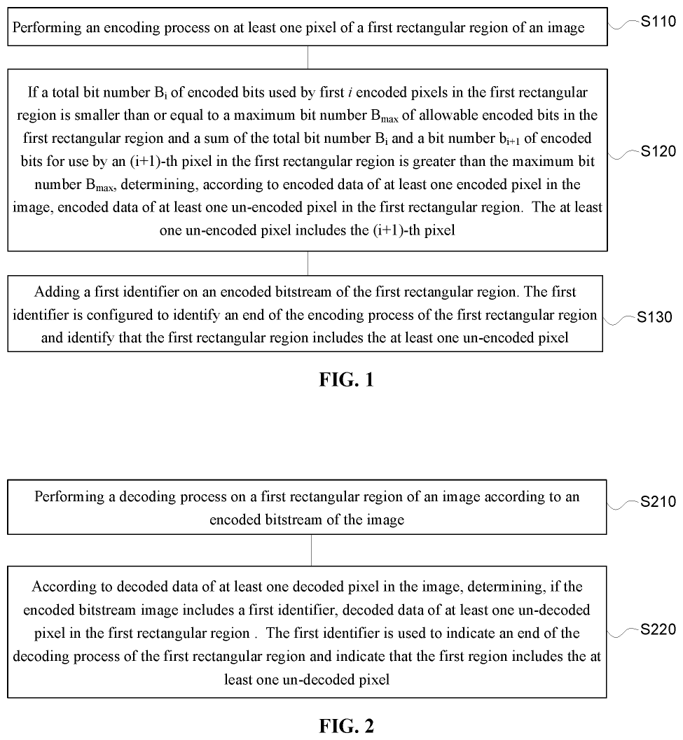

FIG. 1 illustrates an exemplary encoding method 100 provided by one embodiment of the present disclosure. As shown in FIG. 1, the encoding method 100 may include a step S110: performing an encoding processing on at least one pixel in a first rectangular region of the image.

The image may include at least one rectangular region. The at least one rectangular region of the image may include the first rectangular region. In one embodiment, the pixels in the first rectangular region may be encoded in a certain order. For example, the pixels in the first rectangular region may be encoded from left to right. In one embodiment, if the first rectangular region includes a plurality of rows of pixels, the different rows in the first rectangular region may be encoded in a top-to-bottom manner. The encoding manner is not limited by the present disclosure.

The encoding method 100 may also include a step S120: determining the encoding data of the at least one un-encoded pixel in the first rectangular region according to the encoded data of at least one encoded pixel in the image when the total bit number Bᵢ of encoded bits used by the first i encoded pixels in the first rectangular region is less than or equal to the maximum bit number Bₘₐₓ of the allowable encoded bits of the first rectangular region, and the sum of the bit number bᵢ₊₁ of encoded bits to be used by the (i+1)-th pixel in the first rectangle region and Bᵢ is greater than Bₘₐₓ. The at least one un-encoded pixel may include the (i+1)-th pixel, and i is an integer greater than or equal to 1.

In particular, it may be assumed that the first i pixels in the first rectangular region may be encoded, and the (i+1)-th pixel in the first rectangular region may need to be encoded. 1≤i≤T−1, T is the total number of pixels included in the first rectangular region. If the sum Bᵢ of the number of coded bits bᵢ₊₁ needed to be used by the (i+1)-th pixel and the total bits used by the previous i pixels is greater than the maximum allowable bit number Bₘₐₓ of encoded bits of the first rectangular region, it may indicate that the number of encoded bits allowed in the first rectangular region may be insufficient for encoding the (i+1)-th pixel. In particular, the number of encoded bits of the first rectangular region may have been used up and the first rectangular region may still have un-encoded pixels. Under such a condition, the encoded data of at least one un-encoded pixel including the (i+1)-th pixel in the first rectangular region may be determined according to the encoded data of the at least one pixel that has been encoded in the image by using a method of pixel expansion. Under such a condition, the encoded data of the at least one un-encoded pixel may be obtained without performing an encoding process on the at least one un-encoded pixel in the first rectangular region. Similarly, the decoding terminal may also adopt a similar manner to decode data of the at least one un-encoded pixel.

In one embodiment, the encoded data of the at least one pixel that has been encoded in the image may be directly copied to the at least one un-encoded pixel. Thus, the encoded data of the at least one un-encoded pixel may be configured as the encoded data of at least one pixel that has been encoded in the image. In another embodiment, the encoded data of the at least one pixel that has been encoded in the image may be processed, and the processed data may be configured as the encoded data of the at least one un-encoded pixel. The encoded data may be processed by any appropriate method, such as an averaging method; and the processing method may not be limited by the present disclosure.

In one embodiment, the at least one encoded pixel in the image may include an encoded pixel located at the left side of the at least one un-encoded pixel and/or at least one encoded pixel located on the upper side of the at least one un-encoded pixel. The encoded pixel located at the left side of the at least one un-encoded pixel may be adjacent to the at least one un-encoded pixel or may be spaced apart by at least one pixel with the at least one un-encoded pixel. The at least one encoded pixel located on an upper side of the at least one un-encoded pixel may be adjacent to the at least one un-encoded pixel or may be spaced apart from the at least one un-encoded pixel by at least one pixel. The location of the at least one encoded pixel is not limited by the present disclosure.

In one embodiment, the at least one encoded pixel in the image may be located in the first rectangular region or may not be located in the first rectangular region. For example, the image may include at least one sub-image, and each sub-image may include at least one rectangular region. For example, one rectangular region may include one row of pixels, one sub-image may include H rows of pixels, and H may be an integer greater than or equal to 1. Thus, one sub-image may at least include H rectangular regions. Under such a condition, in one embodiment, the at least one encoded pixel in the image may be located in the sub-image to which the first rectangular region belongs. The location of the at least one encoded pixel is not limited by the present disclosure.

In one embodiment, a reference pixel of each pixel of the at least one un-encoded pixel may be determined from at least one encoded pixel in the image, and the encoded data of each pixel of the at least one un-encoded pixel may be configured as the encoded data of the reference pixel of each of the pixels.

In one embodiment, reference pixels of different pixels in the at least one un-encoded pixel may be the same or different. Further, the reference pixel of each of the at least one un-encoded pixel may be predetermined. For example, the reference pixel of each of the at least one un-encoded pixel may be an encoded pixel located on an upper side of each pixel. For another example, the reference pixel of each pixel of the at least one un-encoded pixel may be a pixel located on the left side of the at least one un-encoded pixel in the first rectangular region, such as the last encoded pixel at the first rectangle region. For another example, the reference pixel of each pixel of the at least one un-encoded pixel may be an encoded pixel located on the left side of the pixel and spaced apart from the pixel by P pixels. The selection of the reference pixel is not limited by the present disclosure.

In one embodiment, the reference pixel of each pixel may also be determined according to information of each pixel in the at least one un-encoded pixel. For example, the reference pixel of each pixel may be determined according to the raw data and/or position of each pixel in the at least one un-encoded pixel and the encoded pixel at the left side of each pixel and the encoded pixel on the upper side of each pixel. The selection of the reference pixel is not limited by the present disclosure.

For example, the at least one un-encoded pixel point may be divided into N groups of pixels. Each group of pixels may include at least one pixel of the at least one un-encoded pixel, and N is an integer greater than or equal to 1. For example, the at least one un-encoded pixel may be divided into N groups of pixels according to a preset length. The number of un-encoded pixels included in each of the first N−1 groups of pixels may be the same. The number of the un-encoded pixels included the N-th group of pixels may be equal to the total number of the at least one un-encoded pixel subtracted by the total number of un-encoded pixels included in the first N−1 groups of pixels. In one embodiment, the value of N may be determined by the total number of the at least one un-encoded pixels and the preset length of each group of pixels. For another example, the at least one un-encoded pixel may be divided into two groups of pixels. In particular, N=2. The first group of the two groups of pixels may have a preset length, and the remaining un-encoded pixels in the at least one un-encoded pixel other than the first group of pixels may be configured as the second group of pixels. Under such a condition, the grouping process may be performed without knowing the total number of the at least one un-encoded pixel. Thus, the encoding complexity may be reduced. The at least one un-encoded pixel may be grouped by other methods; and the grouping method of the at least one un-encoded pixel is not limited by the present disclosure.

Thus, for one or more groups of pixels of the N groups of pixels, the reference pixel of the at least one pixel of one group of pixels may be determined by a unit of group. For example, the reference pixel of the j-th group of pixels may be determined according to the raw data of the j-th group of pixels in the N groups of pixels and from the first encoded pixel at the left side of the j-th group of pixels and the at least one second encoded pixel on the upper side of the j-th group of pixels.

In one embodiment, the first encoded pixel may be in the same row as the j-th group of pixels and located at the left side of the j-th group of pixels. For example, the first encoded pixel may the last pixel that has been encoded in the rectangular region, or the first encoded pixel may be spaced from the last encoded pixel in the first rectangular region by at least one pixel. The selection of the first encoded pixel is not limited by the present disclosure. In one embodiment, the at least one second encoded pixel may be located right above the j-th group of pixels. For example, the number of the at least one second encoded pixel may be the same as the number of pixels included in the j-th group of pixels. Each of the at least one second encoded pixel may be located right above the j-th group of pixels. In particular, the at least one second coded pixel may be in one-to-one correspondence with at least one pixel of the j-th group of pixels. One of the j-th group of pixels may be adjacent to or spaced apart from the at least one second encoded pixel located right above the pixel. The position of the pixel is not limited by the present disclosure.

In one embodiment, the first encoded pixel may be configured as a reference pixel of the j-th group of pixels, and the at least one second encoded pixel may also be configured as a reference pixel of the j-th group of pixels. The reference pixel of each of the j-th group of pixels may be the second encoded pixel located right above the pixel. The position of the reference pixel is not limited by the present disclosure.

In one embodiment, a correlation between the j-th group of pixels and the first encoded pixel may be determined; and a correlation between the j-th group of pixels and the at least second encoded pixel may be determined. Further, the at first encoded pixel or the at least one second encoded pixel may be configured as the reference pixel of the j-th group of pixels according to the correlation between the j-th pixel and the first encoded pixel and the correlation between the j-th group of pixels and the at least one second encoded pixel.

In one embodiment, the correlation between the j-th group of pixels and the first encoded pixel may be determined according to a correlation between each pixel of the j-th group of pixels and the first encoded pixel. For example, the correlation between the j-th group of pixels and the first encoded pixel may be the sum of the correlations between each pixel of the j-th group of pixels and the first encoded pixel. The correlation is not limited by the present disclosure.

In one embodiment, the correlation between the j-th group of pixels and the at least one second encoded pixel may be determined according to a correlation between each pixel of the j-th group of pixels and the second encoded pixel on the upper side of each pixel. For example, the correlation between the j-th group of pixels and the at least one second encoded pixel may be the sum of the correlations between each pixel of the j-th group of pixels and the second encoded pixel on each pixel of the j-th group of pixels. The correlation is not limited by the present disclosure.

For example, one of the first encoded pixel and the at least one second encoded pixel having a greater degree of correlation with the j-th group of pixels may be configured as a reference pixel of the j-th group of pixels. For example, if the correlation between the first encoded pixel and the j-th group of pixels is greater than the correlation between the at least one second encoded pixel and the j-th group of pixels, the first encoded pixel may be configured as a reference pixel of the j-th group of pixels. Under such a condition, all the pixels of the j-th group of pixels may have the same reference pixel. For another example, if the correlation between the first encoded pixel point and the j-th group of pixels is smaller than the correlation between the at least one second encoded pixel and the j-th group of pixels, the at least one second encoded pixel may be configured as a reference pixel of the j-th group of pixels. Under such a condition, the reference pixel of each of the j-th group of pixels may be the second encoded pixel on an upper side of each pixel.

In one embodiment, for the N-th group of pixels of the N groups of pixels, the reference pixel of each of the N-th group of pixels may also be determined. For example, the reference pixel of each pixel may be determined according to the raw data and/or position of each pixel of the N-th group of pixels and from the encoded pixel on the left side of each pixel and the encoded pixel on the upper side of each pixel.

Further, the encoding process 100 may include a step S130: adding a first identifier to the encoded bitstream of the first rectangular region. The first identifier may be used to identify that the encoding process of the first rectangular region is finished, and the first rectangular region may have at least one un-encoded pixel.

In one embodiment, the first identifier may need to be distinguished from the encoded bits in the encoded bitstream corresponding to the rectangular region. In particular, the uniqueness of the first identifier in the encoded bitstream corresponding to the rectangular region may need to be ensured. For example, the first identifier may be an end code; and when the 0th-order Columbus code is adopted and the bit depth of the coded pixel is 12, the pattern of the first identifier may be set to consecutive a number 14 of ‘0’. However, the specific first identifier may not be limited by the present disclosure.

In one embodiment, the first identifier may be right after the encoded bit corresponding to the i-th pixel in the first rectangular region. However, the first identifier may not be limited by the present disclosure.

In one embodiment, at least one second identifier may be added to the encoded bitstream of the first rectangular region. Each second identifier may be used to identify the location of a reference pixel of a group of pixels in the N-groups of pixels.

In one embodiment, at least one third identifier may be added to the encoded bitstream of the first rectangular region. Each third identifier may be used to identify the location of a reference pixel of one pixel of the N-th group of pixels.

In one embodiment of the present disclosure, different rectangular regions in the image may be encoded at a fixed magnification. In particular, the numbers of encoded bits corresponding to the rectangular regions of the same length may be less than or equal to the preset number of bits.

In particular, when the number of encoded bits is equal to the preset number of bits, the rectangular regions of the same length may correspond to the same number of coded bits. Accordingly, the rectangular regions in the image may be encoded at a fixed magnification.

When the number of encoded bits is less than or equal to a preset number of bits, the compression ratio of the image corresponding to the rectangular regions may be greater than or equal to the compression ratio of the encoded bits corresponding to the rectangular regions of a same length.

The purpose of such a processing method may be to ensure the encoding compression ratio of the entire image. At the same time, because it may not strictly need to ensure each rectangular region to correspond to a same number of encoded bits, the encoding flexibility of each rectangular region may be improved; and the encoding efficiency may be improved.

Thus, the technical solutions provided by the present disclosure may a lower implementation complexity and may have a higher encoding efficiency.

In some embodiments, some of or all the rectangular regions in the at least one rectangular region in the image may be further divided into at least one segment. Each segment may include at least one pixel. When a rectangular region is divided into a plurality of segments, different segments in the rectangular region may have the same or different lengths. For example, at least one segment spaced apart from the boundary of the rectangular region may have a same length.

In one embodiment, the left-side data or the upper-side data may be used as the reference data of each segment in the rectangular region. Such a selection may be beneficial to improve the encoding quality.

The encoding method of the pixels in the rectangular region in the present disclosure will be described below with reference to specific embodiments.

In the step S110, the reference data of the to-be-encoded segment may be determined. In one embodiment, the reference data of the to-be-encoded segment may be determined from the left-side data and the upper-side data of the to-be-encoded segment according to the data of the to-be-encoded segment.

The left-side data of the to-be-encoded segment may include the data of at least one first pixel located to the left side of the to-be-encoded segment. In one embodiment, the number of the at least one first pixel may be equal to the number of pixels included in the to-be-encoded segment. In another embodiment, the number of the at least one first pixel may be greater or smaller than the number of the pixels included the to-be-encoded segment. The number of the at least one first pixel is not limited by the present disclosure.

The at least one first pixel may be located at the left side of the to-be-encoded segment. In one embodiment, the at least one first pixel may be adjacent to the to-be-encoded segment. In particular, the rightmost pixel of the at least one first pixel may be adjacent to the leftmost pixel of the to-be-encoded segment. In another embodiment, the at least one first pixel may be spaced apart from the to-be-encoded segment. For example, the at least one first pixel and the to-be-encoded segment may be spaced apart by at least one pixel. In particular, the rightmost pixel of the at least one first pixel may be spaced apart from the leftmost pixel of the to-be-encoded segment by at least one pixel. The number of pixels spaced between the at least one first pixel and the to-be-encoded segment may be less than a certain threshold. In particular, the at least one first pixel may be adjacent to the to-be-encoded segment. The positions of the at least one first pixel and the to-be-encoded segment are not limited by the present disclosure.

In one embodiment, the data of the first pixel may refer to the raw data or the encoded data of the first pixel. Correspondingly, the data of the at least one first pixel may include the raw data of each of the at least one first pixel, or may include the encoded data of each of the at least one first pixel, or may include the raw data of a portion of the at least one first pixel and the encoded data of the remaining portion of the at least one pixel, etc. The specific data may not be limited by the present disclosure.

The upper-side data of the to-be-encoded segment may include the data of at least one second pixel located above the to-be-encoded segment. In one embodiment, the number of the at least one second pixel may be equal to the number of pixels included in the to-be-encoded segment. In another embodiment, the number of the at least one second pixel may be greater or smaller than the number of the pixel included the to-be-encoded segment. The number of the at least one second pixel is not limited by the present disclosure.

In another embodiment, the data of the second pixel may refer to the raw data or the encoded data of the second pixel. Correspondingly, the data of the at least one second pixel may include the raw data of each of the at least one second pixel, or may include the encoded data of each of the at least one second pixel, or may include the raw data of a portion of the at least one second pixel and the encoded data of the remaining portion of the at least one second pixel, etc. The specific data is not limited by the present disclosure.

In the present disclosure, the reference data of the segment may be selected from the left-side data and the upper-side data of the segment according to at least one pixel included in the segment. In particular, the reference pixel of the segment may be determined from at least one first pixel at the left side of the segment and at least one second pixel above the segment according to the at least one pixel included in the to-be-encoded segment. For example, at least one first pixel on the left side of the to-be-encoded segment may be configured as a reference pixel of the to-be-encoded segment. Correspondingly, the left-side data of the to-be-encoded segment may be configured as the reference data of the to-be-encoded segment. For example, at least one second pixel above the to-be-encoded segment may be configured as a reference pixel of the to-be-encoded segment. Correspondingly, the upper-data of the to-be-encoded segment may be configured as the reference data of the to-be-encoded segment. As used herein, the reference data may refer to the data of the reference pixel; and may not be limited by the present disclosure.

In some embodiments, the reference pixel of the to-be-encoded segment may be determined from the at least one first pixel and the at least one second pixel according to the correlation between the to-be-encoded segment and the at least one first pixel, and the correlation between the to-be-encoded segment and the at least one second pixel. Correspondingly, according to the correlation between the to-be-encoded segment and the left-side data of the to-be-enAcoded segment and the correlation between the to-be-encoded segment and the upper-side data of the to-be-encoded segment, the reference data of the to-be-encoded segment may be determined from the left-side data and the upper-side data of the to-be-encoded segment.

In one embodiment, the correlation between the to-be-encoded segment and the left-side data may be determined according to the data of at least one pixel included in the to-be-encoded segment and the left-side data of the to-be-encoded segment. For example, the absolute value of the difference between the data of the to-be-encoded segment and the left-side data of the to-be-encoded segment may be determined, and the correlation between the to-be-encoded segment and the left-side data of the to-be-encoded segment may be determined according to the absolute value of the difference. In another embodiment, the correlation between the to-be-encoded segment and the left-side data may be determined according to the variance between the to-be-encoded segment and the left-side data of the to-be-encoded segment or the transformed data, such as the data processed by a Hadamard transform, etc. As an example, a smaller absolute value of the difference between the data of the to-be-encoded segment and the left-side data of the to-be-encoded segment may indicate a larger correlation between the to-be-encoded segment and the left-side data of the to-be-encoded segment.

In one embodiment of the present disclosure, the absolute value of the difference between the data of the to-be-encoded segment and the left-side data of the to-be-encoded segment may be obtained according to the absolute value of the difference between the data of each pixel and the data of a first pixel corresponding to each pixel. For example, the absolute value of the difference between the data of the to-be-encoded segment and the left-side data of the to-be-encoded segment may be a function of the sum of the absolute value of the difference between the data of each pixel in the segment and the data of the first pixel corresponding to each pixel. The function may be an average function or a mean square function, etc., and may be limited by the present disclosure.

For example, one may assume that the data of the to-be-encoded segment may be represented by the following set: {currSegi, i=1, . . . , n}; and the left-side data of the to-be-encoded segment may be represented by the following set: {neiSegj, j=1, . . . , m}. n is the number of pixels included in the to-be-encoded segment, and m is the number of the at least one first pixel. If n=m, the difference between the to-be-encoded segment and the left-side data of the to-be-encoded segment may be determined by:

diff=f(Σᵢ₌₀ⁿcurrSegi−neiSegi) (1)

If n>m, the difference between the to-be-encoded segment and the left-side data of the to-be-encoded segment may be determined by:

diff=f(Σᵢ₌₀ⁿcurrSeg′i−neiSegi) (2)

{currSeg′i , i=1, . . . , m} may be m data obtained by sampling the data {currSeg′i i=1, . . . , n} of the to-be-encoded segment with a specific step size. The sampled data may be obtained by averaging the data within a specific step size in the data of the to-be-encoded segment, or may be obtained by extracting a point in the data of the to-be-encoded segment within a specific step size, etc. The method for obtaining the m data may not be limited by the present disclosure. In another embodiment, the particular step size may be determined based on n and m. For example, if n is equal to an integer time of m, the particular step size may optionally be a divisor of n and m. If n is not equal to an integer time of m, the particular step size may optionally be the approximation of the divisor of n and m. For example, the divisor of n and m may be obtained by ceiling, floor, or rounded off. The method for obtaining the divisor may not be limited by the present disclosure.

If n<m, the difference between the data of the to-be-encoded segment and the left-side data of the to-be-encoded segment may be determined by:

diff=f(Σᵢ₌₀ⁿcurrSegi−neiSeg′i) (3)

{neiSeg′i , i=1, . . . , m} may be n data obtained by sampling the left-side data {neiSegi, i=1, . . . , n} of the to-be-encoded segment with a specific step size. The sampled data may be obtained by averaging data within a specific step size in the left-side data of the to-be-encoded segment, or may be obtained by extracting a point in the left-side data of the to-be-encoded segment within the specific step size. The method for obtaining the n data may not be limited by the present disclosure. In another embodiment, the particular step size may be determined based on n and m. For example, if m is equal to an integer time of n, the particular step size may optionally be a divisor of n and m. If m is not equal to an integer time of n, the particular step size may optionally be the approximation of the divisor of n and m. For example, the divisor of n and m may be obtained by ceiling, floor, or rounded off. The method for obtaining the divisor may not be limited by the present disclosure.

In one embodiment of the present disclosure, the left-side data of the to-be-encoded segment and the data of the upper-side data having a greater degree of correlation with the to-be-encoded segment may be configured as the reference data of the to-be-encoded segment. The reference data is not limited by the present disclosure.

In another embodiment, if the to-be-encoded segment has only an available left-side data and no available upper-side data, the left-side data of the to-be-encoded segment may be configured as the reference data the to-be-encoded segment. In still another embodiment, if the to-be-encoded segment has only an available upper-side data and no available left-side data, the upper-side data of the to-be-encoded segment may be configured as the reference data of the to-be-encoded segment.

In one embodiment, one segment may use any data in the image as the reference data. In particular, the segment may use any data in an image in a same rectangular region or a different rectangular region as the reference data. For example, to improve the encoding quality, a segment may use the upper-side data of the segment as much as possible (for example, above the segment) as the reference data regardless whether the pixel corresponding to the upper-side data belongs to the same rectangular area. In another embodiment, a segment may only use the data in a rectangular region to which the segment belongs as the reference data and may use the data in the region other than the rectangular region to which the segment belongs as a reference data. Thus, the codecs between different rectangular regions in the image may be independent of each other. In another embodiment, the image may be divided into at least one sub-image. Each sub-image may include at least one rectangular region. For example, one rectangular region may include one row of pixels; and one sub-image may include H rows of pixels. H is an integer greater than or equal to 1. Under such a configuration, a sub-image may include at least H rectangular regions. The number of the rectangular region in one sub-image may not be limited by the present disclosure. One segment may only use data in the sub-image to which the segment belongs as the reference data. For example, the data in the same rectangular region as the segment and in the sub-image to which the segment belongs may be used as the reference data. Or, the data belonging to different rectangular regions may not be used as the reference data.

In one embodiment, if the to-be-encoded segment is not adjacent or spaced apart from the upper boundary of the rectangular region to which the to-be-encoded segment belongs, the to-be-encoded segment may be determined to have an available upper data. Correspondingly, if the to-be-encoded segment is adjacent to the upper boundary of the rectangular region to which the to-be-encoded region belongs, the to-be-encoded segment may be determined not to have an available upper-side data. In another embodiment, if the to-be-encoded segment is not adjacent to or spaced apart from the upper boundary of the image, the to-be-encoded segment may be determined to have an available upper-side data. Accordingly, if the to-be-encoded segment is adjacent to the upper boundary of the image, the to-be-encoded segment may be determined not to have an available upper-side data. In another embodiment, if the to-be-encoded segment is not adjacent to or spaced apart from the upper-boundary of the sub-image to which the to-be-encoded segment belongs, the to-be-encoded segment may be determined to have an available upper-side data. Correspondingly, if the to-be-encoded segment is adjacent to the upper boundary of the sub-image to which the to-be-encoded segment belongs, the to-be-encoded segment may be determined not to have the available upper-side data.

If the to-be-encoded segment is not adjacent to or spaced apart from the left boundary of the rectangular region to which the to-be-encoded segment belongs, the to-be-encoded segment may be determined to have an available left-side data. Correspondingly, if the to-be-encoded segment is adjacent to the left boundary of the rectangular region to which the to-be-encoded segment belongs, the to-be-encoded segment may be determined not to have an available left-side data. In another embodiment, if the to-be-encoded segment is not adjacent to or spaced apart from the left boundary of the image, the to-be-encoded segment may be determined to have an available left-side data. Correspondingly, if the to-be-encoded segment is adjacent to the left boundary of the image, the to-be-encoded segment may be determined not to have an available left side data. In another embodiment, if the to-be-encoded segment is not adjacent to or spaced apart from the left boundary of the sub-image to which the to-be-encoded segment belongs, the to-be-encoded segment may be determined to have an available left-side data. Correspondingly, if the to-be-encoded segment is adjacent to the left side of the sub-image to which the to-be-encoded segment, the to-be-encoded segment may be determined not to have an available left-side data.

In another embodiment, whether the segment has available upper-side data and whether the segment has available left-side data may have the same criterion.

The reference data of the to-be-encoded segment may be determined from the left-side data and the upper-side data of the to-be-encoded segment. If the to-be-encoded segment have an available left-side data and an available upper-side data, the reference data of the to-be-encoded segment may be determined from the available left-side data of the to-be-encoded segment and the available upper-side data of the to-be-encoded segment.

Under the condition that the to-be-encoded segment may have an available left-side data and an available upper-side data, the reference data of the to-be-encoded segment may be determined from the available left-side data and the available upper-side data.

In one embodiment, if the to-be-encoded segment has only available left-side data, the left-data of the to-be-encoded segment may be configured as the reference data of the to-be-encoded segment.

In one embodiment, if the to-be-encoded segment has only available upper-side data, the upper-side data of the to-be-encoded segment may be determined as the reference data of the to-be-encoded segment.

In one embodiment, whether the to-be-encoded segment has available left-side data and/or upper-side data may be determined according to whether the to-be-encoded segment is located at a boundary of a rectangular region, a boundary of a sub-image, or a boundary of an image.

For example, the data belonging to the same image as the to-be-encoded segment may be used as available left-side data and/or available upper-side data of the to-be-encoded segment. Correspondingly, whether the to-be-encoded segment has available left-side data and/or upper-side data may be determined according to whether the to-be-encoded segment is located at the boundary of the image.

In one embodiment, the upper-side data of the to-be-encoded segment may be used as the reference data of the to-be-encoded segment, and the encoding quality may be improved.

In one embodiment, if the to-be-encoded segment is adjacent to an upper boundary of the image and the to-be-encoded segment is spaced apart from a left boundary of the image, the pixels in the segment may be encoded according to the left-side data of the to-be-encoded segment.

In particular, if the to-be-encoded segment is adjacent to an upper boundary of the image and the to-be-coded segment is spaced apart from a left boundary of the image, the to-be-encoded segment may have an available left-side data and the upper-side data may be not available. Under such a condition, the left-side data of the to-be-encoded segment may be configured as the reference data of the to-be-encoded segment. The left-side data of the to-be-encoded segment may refer to the data of at least one pixel in the image located at the left side of the to-be-encoded segment.

In one embodiment, if the to-be-encoded segment is spaced apart from an upper boundary of the image and the to-be-encoded segment is adjacent to a left boundary of the image, the pixels of the to-be-encoded segment may be encoded according to the upper-side data of the to-be-encoded segment.

In particular, if the to-be-encoded segment is adjacent to the left boundary of the image and the to-be-encoded segment is spaced apart from the upper boundary of the image, the to-be-encoded segment may have an available upper-side data and the left-side data may be not available. Under such a condition, the upper-side data of the to-be-encoded segment may be configured as the reference data of the to-be-encoded segment. The upper-side data of the to-be-encoded segment may refer to the data of at least one pixel in the image located above the to-be-encoded segment.

In another embodiment, only the data belonging to the same rectangular region as the to-be-encoded segment may be used as the available left-side data and/or the upper-side data of the to-be-encoded segment. Correspondingly, when the to-be-encoded segment belongs to the first rectangular region, whether the to-be-encoded segment has an available left side data and/or upper-side data may be determined according to whether the to-be-encoded segment is located at a boundary of the first rectangular region.

Under such a condition, the encoding between the respective rectangular regions may be independent of each other.

In one embodiment, if the to-be-encoded segment is adjacent to an upper boundary of the first rectangular region and the to-be-encoded segment is spaced apart from a left boundary of the first rectangular region, the pixels of the to-be-encoded segment may be encoded according to the left-side data of the to-be-encoded segment.

In particular, if the to-be-encoded segment is adjacent to an upper boundary of the first rectangular region and the to-be-encoded segment is spaced apart from a left boundary of the first rectangular region, the to-be-encoded segment may have an available left side data and may not have have available upper side data. Under such a condition, the left side data of the to-be-encoded segment may be configured as the reference data of the to-be-encoded segment. The left-side data of the to-be-encoded segment may be the data of at least one pixel belonging to a same rectangular region as the to-be-encoded segment (i.e., located at the first rectangular region) and located at the left side of the to-be-encoded segment.

In one embodiment, if the to-be-encoded segment is spaced apart from an upper boundary of the first rectangular region and the to-be-encoded segment is adjacent to a left boundary of the first rectangular region, the pixels of the to-be-encoded segment may be encoded according to the upper-side data of the to-be-encoded segment.

In particular, if the to-be-encoded segment is adjacent to a left boundary of the first rectangular region and the to-be-encoded segment is spaced apart from an upper boundary of the first rectangular region, the to-be-encoded segment may have an available upper-side data but may not have an available left-side data. Under such a condition, the upper-side data of the to-be-encoded segment may be configured as the reference data of the to-be-encoded segment. The upper-side data of the to-be-encoded segment may refer to the data of at least one pixel belonging to the same rectangular region as the to-be-encoded segment (i.e., located in the rectangular region) and located above the to-be-encoded segment.

In another embodiment, the image may include at least one sub-image and each sub-image may include at least one rectangular region. For example, each sub-image may include one or more rectangular regions along the height direction.

Under such a condition, in one embodiment, only the data belonging to the same sub-image as the to-be-encoded segment may be used as the available left-side data and/or upper-side data for the to-be-encoded segment. Correspondingly, whether the to-be-encoded segment has an available left-side data and/or upper-side data may be determined according to whether the to-be-encoded segment is located at the boundary of the sub-image to which it belongs.

In one embodiment, if the to-be-encoded segment is adjacent to an upper boundary of the sub-image to which the to-be-encoded segment belongs, and the to-be-encoded segment is spaced apart from a left boundary of the sub-image to which the to-be-encoded segment belongs, the pixel in the to-be-encoded segment may be encoded according to the left-side data of the to-be-encoded segment.

In particular, if the to-be-encoded segment is adjacent to the upper boundary of the sub-image to which it belongs and the to-be-encoded segment is spaced apart from the left boundary of the sub-image to which it belongs, the to-be-encoded segment may have an available left-side data but may not have the available upper-side data. Under such a condition, the left-side data of the to-be-encoded segment may be configured as the reference data of the to-be-encoded segment. The left-side data of the to-be-encoded segment may refer to the data of at least one pixel belonging to the same sub-image as the to-be-encoded segment and located at the left side of the to-be-encoded segment.

In one embodiment, if the to-be-encoded segment is spaced apart from an upper boundary of the sub-image to which the to-be-encoded segment belongs, and the to-be-encoded segment is adjacent to a left boundary of the sub-image to which the to-be-encoded segment belongs, the pixel of the to-be-encoded segment may be encoded according to the upper-side data of the to-be-encoded segment.

In particular, if the to-be-encoded segment is adjacent to the left boundary of the sub-image to which it belongs and the to-be-encoded segment is spaced apart from the upper boundary of the sub-image to which it belongs, the to-be-encoded segment may have an available upper-side data but may not have available left-side data. Under such a condition, the upper-side data of the to-be-encoded segment may be configured as the reference data of the to-be-encoded segment. The upper-side data of the to-be-encoded segment may refer to the data of the at least one pixel belonging to the same sub-image as the to-be-encoded segment and located above the to-be-encoded segment.

In another embodiment, whether the to-be-encoded segment has an available upper-side data and left-side data may also be determined according to different criteria. For example, the to-be-encoded segment may use the upper-side data in the same sub-image as the available upper-side data and only the left-side data in the same rectangular region as the available left-side data. For another example, the to-be-encoded segment may use the left-side data in the same sub-image as the available left-side data and only the left-side data in the same rectangular region as the available left-side data.

In one embodiment, if the to-be-encoded segment is adjacent to a left boundary of the sub-image to which the to-be-encoded segment belongs and the to-be-encoded segment is spaced apart from an upper boundary of the image, the pixel in the to-be-encoded segment may encoded according to the upper-side data of the to-be-encoded segment.

In particular, only the data in the same sub-image as the to-be-encoded segment may be used as the available left-side data of the to-be-encoded segment, and the data located above the to-be-encoded segment in the image may be used as the available upper-side data of the to-be-encoded segment. Correspondingly, whether the to-be-encoded segment has an available left-side data may be determined according to whether the to-be-encoded segment is located at a left boundary of the sub-image to which it belongs, and whether the to-be-encoded segment has an available upper-side data may be determined according to whether the to-be-encoded segment is located at an upper boundary of the image.

In one embodiment, if the to-be-encoded segment is adjacent to a left boundary of the sub-image and the to-be-encoded segment is spaced apart from an upper boundary of the image. Under such a condition, when the to-be-encoded segment is above the upper boundary of the sub-image, the to-be-encoded segment may be considered to have an available upper-side data. Under such a condition, the upper-side data of the to-be-encoded segment may be configured as the reference data of the to-be-encoded segment. The upper-side data of the to-be-encoded segment may refer to the data of at least one pixel located in the image above the to-be-encoded segment.

In one embodiment, if the to-be-encoded segment is adjacent to an upper boundary of a sub-image to which the to-be-encoded segment belongs and the to-be-encoded segment is spaced apart from a left boundary of the image, the pixel of the to-be-encoded segment may be encoded according to the left-side data of the to-be-encoded segment.

In one embodiment, only the data belonging to the same sub-image as the to-be-encoded segment may be used as the upper-side data of the to-be-encoded segment, and the data in the image and located at the left side of the to-be-encoded segment may be used as the available left-side data of the to-be-encoded segment. Correspondingly, whether the to-be-encoded segment has an available upper-side data may be determined according to whether the to-be-encoded segment is located at an upper boundary of the sub-image to which it belongs, and whether the to-be-encoded segment has an available left-side data may be determined according to whether the to-be-encoded segment is located at a left boundary of the image.

In one embodiment, if the to-be-encoded segment is adjacent to an upper boundary of the sub-image to which the to-be-encoded segment belongs, and the to-be-encoded segment is spaced apart from the left boundary of the image. Under such a condition, when the to-be-encoded segment is at the left boundary of the sub-image to which the to-be-encoded segment belongs, the to-be-encoded segment may be considered to have an available left-side data. Under such a condition, the left-side data of the to-be-encoded segment may be configured as the reference data of the to-be-encoded segment. The left-side data of the to-be-encoded segment may refer to the data of at least one pixel in the image and located at the left side of the to-be-encoded segment.

As another optional embodiment, the to-be-encoded segment may not have available upper-side data and does not have available left-side data. For example, the to-be-encoded segment may be adjacent to the upper boundary of the image, or the upper boundary of the sub-image to which the to-be-encoded segment belongs may be adjacent to the upper boundary of the rectangular region to which the to-be-encoded segment. Further, the to-be-encoded segment may be adjacent to the left boundary of the image, the left boundary of the sub-image to which the segment to be encoded belongs, or the left boundary of the rectangular region to which the encoded segment belongs may be adjacent. If the length of the to-be-encoded segment is greater than a certain threshold, that is, the number of pixels in the same row included in the to-be-encoded segment is greater than a certain threshold, the data of at least one pixel in the preceding segment of the to-be-encoded segment may be used as the reference data of at least one pixel after the to-be-encoded segment.

For example, if the number T of the pixels in the same row included in the to-be-encoded segment is greater than N, the predicted value of the first N pixels in the to-be-encoded segment may be determined as a preset value. For example, 1<<(BitDepth−1) may be determined as the predicted value of the first N pixel points, “<<” is the left shift operator, and BitDepth is the pixel bit depth, which indicates the number of the encoded bits used by each un-encoded pixel. When encoding the remaining (T−N) pixels in the to-be-encoded segment, a pixel j located at the left side of the pixel i and spaced apart from the pixel i by L pixels may be used as the reference pixel of the pixel i. The value of the pixel j used as the reference pixel may be the value of the original pixel of the pixel point j or the value of the encoded reconstructed pixel of the pixel point j.

In one embodiment of the present disclosure, the pixels in the segment may be encoded/decoded by the degree of parallelism M. In particular, the M pixels may be encoded/decoded at the same time. M is an integer greater than or an integer equal to 1. For example, every adjacent M pixels in the to-be-encoded segment may correspond to a same reference pixel. The M adjacent pixels may be located in the same row.

In one embodiment of the present disclosure, N (the number of the groups of pixels) may be determined by M and a sequential logic delay L. The sequential logic delay L may be determined by the structure of the hardware design, such as the number of levels of the chip pipeline design, etc. L may be the maximum value of the delay value of the pixel encoded at the encoding terminal and the delay value of the pixel decoded at the decoding terminal.

In one embodiment, in the step S110, after determining the reference data of the to-be-encoded segment, the be-encoded-segment to may be encoded according to the reference data to obtain an encoded bitstream of the to-be-encoded segment.

In one embodiment, the to-be-encoded segment may be subjected to a prediction process according to the reference data to obtain a prediction residual of the to-be-encoded segment. Then, the prediction residual of the to-be-encoded segment may be quantized by using the quantization parameters of the to-be-encoded segment to obtain a quantized result of the to-be-encoded segment. Then, the quantized result of the to-be-encoded segment may be subjected to an entropy encoding processing to obtain an encoded result of the to-be-encoded segment.

In particular, the prediction residual of the to-be-encoded segment may include an absolute value of the residual value of each pixel in the to-be-encoded segment. In one embodiment, the absolute value of the residual value of the pixel may be the absolute value of the difference between the raw data of the pixel and the raw data of the reference pixel corresponding to the pixel.

The quantization result of the to-be-encoded segment may be obtained by performing a quantizing process on the residual of each pixel in the to-be-encoded segment. In one embodiment of the present disclosure, the quantization process may be quantized in the H.264/AVC standard, in the H.265/HEVC standard, in the AVS1-P2 standard, in the AVS2-P2 standard, or a self-designed quantization table, etc.

In one embodiment of the present disclosure, the entropy encoding process may be a lossless coding process, and specifically, the Nth order Golomb encoding and a context-based adaptive variable length encoding (AVLC), the content-based adaptive binary arithmetic encoding (CABAC), etc.

In another embodiment, the quantization parameters of the to-be-encoded segment may also be determined according to the reference data. For example, the original quantization parameters may be updated according to the reference data to obtain the quantization parameters of the to-be-encoded segment. The original quantification parameters may be the initial quantization parameters of the to-be-encoded segment. For example, the original quantization parameters may be the initial quantization parameters of the image, or the quantization parameters of a previous segment of the to-be-encoded segment, etc.

In one embodiment of the present disclosure, the quantization parameters may include a quantization step, a value related to the quantization step or indicating the quantization step (for example, QP), a quantization matrix, or a quantization index, etc.

In one embodiment, the complexity of the to-be-encoded segment may be determined according to the reference data. The quantization parameters of the to-be-encoded segment may be determined according to the complexity of the to-be-encoded segment.

In one embodiment, the quantization parameters of the to-be-encoded segment may be determined according to the complexity of the to-be-encoded segment and the total complexity of the rectangular region to which the to-be-encoded segment belongs.

In one embodiment of the present disclosure, the residual of each pixel may be determined according to the reference data of the to-be-encoded segment and the data of each pixel in the to-be-encoded segment, and the complexity of the to-be-encoded segment may be determined according to the residual of each pixel in the to-be-encoded segment. In still one embodiment, the residual of each pixel may be determined according to the data of each pixel in the to-be-encoded segment and the data of a reference pixel of each pixel. The reference data of the to-be-encoded segment may include the data of the reference pixel of each pixel in the to-be-encoded segment.

In one embodiment, the total complexity of the rectangular region to which the to-be-encoded segment belongs may be determined according to the complexity of each segment included in the rectangular region to which the to-be-encoded segment belongs. For example, the total complexity of a rectangular region may be an average value of the complexity of a plurality of segments included in the rectangular region.

In another embodiment, the quantization parameters of the to-be-encoded segment may be determined by comparing the complexity of the to-be-encoded segment and the total complexity of the rectangular region to which the to-be-encoded segment belongs. For example, if the complexity of the to-be-encoded segment is greater than the total complexity of the rectangular region to which the to-be-encoded segment belongs, the original quantization parameters may be reduced to obtain the quantization parameters of the to-be-encoded segment. For another example, if the complexity of the to-be-encoded segment is smaller than the total complexity of the rectangular region to which the to-be-encoded segment belongs, the original quantization parameters may be increased to obtain quantization parameters of the to-be-encoded segment. For example, if the complexity of the to-be-encoded segment is equal to the total complexity of the rectangular region to which the to-be-encoded segment belongs, the original quantization parameters may be kept unchanged. In particular, the quantization parameters of the to-be-encoded segment may be equal to the original quantization parameters. There is no limit to this.

After determining the quantization parameters of the to-be-encoded segment, the to-be-encoded segment may be encoded by using the quantization parameters of the to-be-encoded segment.

Accordingly, under the condition that the number of encoded bits corresponding to the rectangular region is a constant, the quantization parameters of each segment and the corresponding number of encoded bits may be determined according to the data included in each segment in the rectangular region. Thus, the encoding quality may be improved.

In one embodiment of the present disclosure, after determining the reference data of the to-be-encoded segment, a fourth identifier may be added to the encoded bitstream of the to-be-encoded segment. The fourth identifier may be used to indicate the location of the reference data of the to-be-encoded segment. For example, the fourth identifier may be used to indicate whether the reference data of the to-be-encoded segment is located at the left side or the upper side of the to-be-encoded segment. The fourth identifier may further indicate the coordinates of the reference data of the to-be-encoded segment. For example, the fourth identifier may indicate how many pixels are between one segment and the to-be-encoded segment.

For example, the fourth identifier corresponding to each segment may be added to the header information of the encoded bit stream of the image to identify the location of the reference data of the segment.

In one embodiment of the present disclosure, for each of the previous one or more segments in the rectangular region, the left-side data or the upper-side data of the segment may be configured as reference data of the segment, the segment may be encoded according to the reference data of the segment until the total number of encoded bits used by the encoded pixels in the rectangular region is less than or equal to the allowed number of encoded bits in the rectangular region, and the number of the required encoded bits for the current to-be-encoded pixels in the rectangular region and the total number of encoded bits used for the previously encoded pixel are greater than the number of allowed encoded bits in the rectangular region. Then, for the remaining un-encoded pixels in the rectangular region, the encoded data or the encoded data of the un-encoded pixels in the rectangular region may be determined according to the encoded data or the encoded data of the encoded pixels in the rectangular region. Thus, the encoding quality may be improved.

FIG. 2 illustrates an exemplary decoding method 200 consistent with various disclosed embodiments of the present disclosure.

As shown in FIG. 2, the decoding method 200 may include a Step S210: performing a decoding process on the first rectangular region of the image according to the encoded bitstream of the image.

In one embodiment, the first rectangular region may be divided into at least one segment. Each segment may include at least one pixel. The decoding processing 200 may be performed with a unit of a segment.

In one embodiment, the encoded bitstream of the image may include a fourth identifier corresponding to each of the at least one segment included in the image. The fourth identifier corresponding to each segment may be used to identify the location of the reference data (or reference pixel) for each segment. Under such a condition, the reference data of the to-be-decoded segment may be determined according to the fourth identifier corresponding to the to-be-decoded segment, and the to-be-de4edersw21′ coded segment may be determined to perform the decoding process according to the reference data of the to-be-decoded segment.

In one embodiment of the present disclosure, different segments may correspond to different fourth identifiers. Correspondingly, the location of the reference data of each segment may be determined according to the fourth identifier corresponding to each segment.

For example, the to-be-decoded segment of the first rectangular region may be subjected to an entropy decoding process to obtain quantization parameters of the to-be-decoded segment. Then, the to-be-decoded segment may be inversely quantized according to the quantization parameters of the to-be-decoded segment to obtain the residual data of the to-be-decoded segment. Then, the residual data of the to-be-decoded segment may be subjected to an inverse prediction process or a compensation process according to the reference data of the to-be-decoded segment to obtain a decoded result of the to-be-decoded segment.

The decoding method 200 may also include a step S220: determining the decoded data of at least one un-decoded pixel in the first rectangular region according to the decoded data of the at least one decoded pixel in the image if the encoded bitstream includes a first identifier. The first identifier may be configured to identify the end of the encoding process of the first rectangular region and to confirm that the first rectangular region may have at least one un-encoded pixel.

In one embodiment, a reference pixel of each of the at least one un-decoded pixel in the first rectangular region may be determined from the at least one decoded pixel of the image, and the decoded data in the at least one un-decoded pixel may be configured as the decoded data of the reference pixel of each pixel.

In one embodiment, a reference pixel of each un-decoded pixel in the first rectangular region may be determined according to at least one second identifier included in the encoded bitstream of the image.

For example, the at least one un-decoded pixel may be divided into N groups of pixels. Each group of pixels may include at least one pixel of the at least one un-decoded pixel. Under such a condition, for one or more groups of pixels of the N groups of pixels, the reference pixel of the j-th group of pixels may be determined from the at least one decoded pixel of the image; and 1≤j≤N.

In one embodiment, the at least one un-decoded pixel may be divided into the N groups of pixels according to the number of the at least one un-decoded pixel. The numbers of un-decoded pixels included the first N−1 groups of pixels of the N groups of pixels may be the same. Under such a condition, the number of the N-th group of pixels may be equal to the number of the at least one un-decoded pixel minus the total number of the pixels included in the first N−1 groups of pixels. In one embodiment, the number of the pixels included in the first N−1 groups of pixels may be predefined.

In one embodiment, the at least one un-decoded pixel may also be divided into two groups of pixels. The first P pixels of the at least one un-decoded pixel may be configured as the first group of pixels. P is a preset value greater than or equal to 1. The remaining un-decoded pixels of the at least one un-decoded pixels other than the first group of pixels may be determined as a second group of pixels. Under such a condition, it may not be necessary to know the total number of the at least one un-decoded pixel.

In one embodiment of the present disclosure, the reference pixel of the j-th group of pixels may be determined in various manners. For example, a second identifier may be obtained from the encoded bitstream of the image, and the second identifier may be used to indicate a location of the reference pixel of the j-th group of pixels, and the reference pixel of each pixel in the j-th group of pixels may be determined according to the second identifier.

In one embodiment, the encoded bitstream of the image may include a second identifier corresponding to the at least one of the N groups of pixels, and the second identifier corresponding to each group of pixels may be used to identify the location of the reference pixel of each group of pixels. Under such a condition, the reference pixel of each group of pixels may be determined according to the second identifier corresponding to each group of pixels in the at least one group of pixels.

In one embodiment, for the N-th group of pixels of the N groups of pixels, a reference pixel may be determined for each of the N-th group of pixels. For example, at least one third identifier may be obtained from the encoded bitstream of the image. The at least one third identifier may correspond to at least one pixel of the N-th group of pixels. Each third identifier of the at least one third identifier may be used to indicate a location of a reference pixel of the corresponding pixel, and a reference pixel of each pixel may be determined according to the third identifier corresponding to each pixel of the second group of pixels.

In one embodiment, the implementation principle of the decoding method provided by present disclosure may be similar to the encoding method; and the details may be referred to the description of the encoding method.

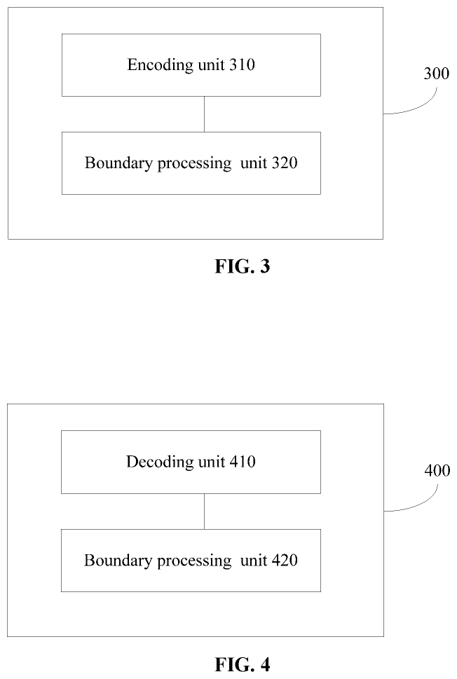

FIG. 3 illustrates an exemplary encoding apparatus 300 consistent with various embodiments of the present disclosure.

As shown in FIG. 3, the encoding apparatus 300 may include an encoding unit 301. The encoding unit 310 may be configured to perform an encoding process on the pixel in the first rectangular region of the image. The image may include at least one rectangular region; and each rectangular region may include at least one pixel.

The encoding apparatus 300 may also include a boundary processing unit 320. The boundary processing unit 320 may be configured to determine the encoded data of at least one un-encoded pixel in the rectangular region according to the encoded data of at least one encoded pixel in the image if the total bit number Bi of encoded bits used by the first i encoded pixels in the first rectangular region is less than or equal to the maximum allowed coded bit number Bmax of the first rectangular region, and the sum bi+1 of the number of encoded bits needed by the (i+1)-th pixel in the first rectangular region and Bi is greater than Bmax. The at least one un-encoded pixel includes the (i+1)-th pixel, and 1≤i≤T−1. T is a total number of pixels included in the first rectangular region. A first identifier may be added to the encoded bitstream of the first rectangular region. The first identifier may identify an end of the encoding process of the first rectangular region and the first rectangular region may have at least one un-encoded pixel.

In one embodiment, the boundary processing unit 320 may be configured to determine a reference pixel of each of the at least one un-encoded pixel from the at least one encoded pixel in the image, and configure the encoded data (or the encoded data) of each of the at least one un-encoded pixel as the encoded data (or encoded data) of the reference pixel of each pixel.

In one embodiment, a reference pixel of each pixel of the at least one un-encoded pixel may be located at a left side or on an upper side of the pixel.

In one embodiment, the reference pixel of each pixel of the at least one un-encoded pixel may be located in the same rectangular region or different rectangular regions as each pixel.

In another embodiment, the boundary processing unit 320 may be configured to divide the at least one un-encoded pixel into N groups of pixels, and determine a reference pixel of the j-th group of pixels of the N groups of pixels form the at least one encoded pixel of the image. Each group of pixels may include at least one pixel of the at least one un-encoded pixel. N may be an integer greater than or equal to 1; and 1≤j≤N.

In some embodiments, the boundary processing unit 320 may be configured to determine the reference pixel of the j-th group of pixels from the first encoded pixel at the left side of the j-th group of pixels and at least one second encoded pixel on the upper side of the j-th group of pixels according to the raw data of the j-th group of pixels.

In still some embodiments, the boundary processing unit 320 may be configured to a correlation between each pixel and the first encoded pixel according to the raw data of each pixel of the j-th group of pixels; determine a correlation between each pixel and at least one second encoded pixel on an upper side of the pixel according to the raw data of each pixel of the j-th group of pixels; and determine the first encoded pixel or the at least one second encoded pixel as the reference pixel of the j-th group of pixels according to the correlation between each pixel of the j-th group of pixels and the first encoded pixel, and each pixel of the j-th group of pixels and the at least one second encoded pixel on the upper side of each pixel.

In one embodiment, the first encoded pixel may be the last encoded pixel of the first i encoded pixels, or the first encoded pixel and the last encoded pixel may be spaced apart by at least one pixel.

In one embodiment, each pixel of the j-th group of pixels may be adjacent to the second encoded pixel or spaced apart by at least one pixel from the second encoded pixel located on an upper side of the pixel.

In some embodiments, the boundary processing unit 320 may also be configured to add a second identifier to the encoded bitstream of the first rectangular region. The second identifier may be used to indicate the location of the reference pixel of the j-th group of pixels.

In some embodiments, the boundary processing unit 320 may be configured to divide the at least one un-encoded pixel into N groups of pixels according to the number of the at least one un-encoded pixel. The number of the un-encoded pixels included in the first N−1 group of the N groups of pixels may be the same.

In one embodiment, N is equal to two. Under such a condition, the boundary processing unit 320 may be configured to determine the first P pixels in the at least one un-encoded pixel as the first group of pixels and the remaining un-encoded pixels in the at least one un-encoded pixels other than the first group of pixels as the second group of pixels. P is a preset value greater than or equal to 1.

In one embodiment, the j-th group of pixels may be the first group of pixels. Correspondingly, the boundary processing unit 320 may be configured to determine the reference pixel of each of the pixels from the encoded pixel at the left side of each pixel and the encoded pixel on the upper side of each pixel according to the raw data of each pixel in the second group of pixels.

In one embodiment, the boundary processing unit 320 may be further configured to add at least one third identifier to the encoded bitstream of the first rectangular region. The at least one third identifier may correspond to at least one pixel of the second group of pixels, and each of the at least one third identifier may be used to indicate a location of the reference pixel of the corresponding pixel.

In some embodiments, the first rectangular region of the image may include at least one segment; and each segment may include at least one pixel. The encoding unit 310 may be configured to determine a reference data of the at least one to-be-encoded segment in the first rectangular region; perform a prediction process on the to-be-encoded segment according to the reference data to obtain a prediction residual of the to-be-encoded segment; perform a quantization process on the prediction result of the to-be-encoded segment using the quantization parameters of the to-be-encoded segment to obtain a quantization result of the to-be-encoded segment; and performing a entropy encoding process on the quantized result of the to-be-encoded segment to obtain an encoded result of the to-be-encoded segment.

In one embodiment, the encoding unit 310 may be configured to determine the reference data of the to-be-encoded segment from the left-side data and the upper-side data of the to-be-encoded segment according to the data in the to-be-encoded segment. The data on the left side of the to-be-encoded segment may include the data of at least one first pixel located on the left side of the to-be-encoded segment, and the upper side data of the data of the to-be-encoded segment may include at least one second pixel located on the upper side of the to-be-encoded. segment.

In one embodiment of the present disclosure, the image may include at least one rectangular region. Each rectangular region may include at least one segment, and each segment may include at least one pixel.

In one embodiment of the present disclosure, the number of the encoded bits corresponding to the rectangular regions of a same length may be less than or equal to the preset number of bits.

In particular, when the number of encoded bits is equal to the preset number of bits, the rectangular regions of the same length correspond to the same number of coded bits. That is, the rectangular regions in the image may be encoded at a fixed magnification.

When the number of encoded bits is less than or equal to the preset number of bits, the compression ratio of the image corresponding to the rectangular regions may be greater than or equal to the compression ratio of the same number of encoded bits corresponding to the rectangular regions of the same length.

The purpose of the processing method may be to ensure the encoding compression ratio of the entire image. At the same time, because it may not be strictly guaranteed that each rectangular region corresponds to a same number of encoding bits, the encoding flexibility of each rectangular region may be improved, and the encoding efficiency can be improved.

In one embodiment of the present disclosure, the left-side data of the to-be-encoded segment may include the data of at least one first pixel located at the left side of the to-be-encoded segment, and the upper-side data of the to-be-encoded segment may include the data of at least one second pixel above the to-be-encoded segment.

The reference data of the to-be-encoded segment may refer to the data of the reference data of the to-be-encoded segment. Correspondingly, the process of determining the reference data of the to-be-encoded segment may include determining the reference data of the to-be-encoded segment. The location of the reference data of the to-be-encoded segment may be the left side or the upper side of the to-be-encoded segment. In particular, the location of the reference data of the to-be-encoded segment may be determined by the data and/or the location of the to-be-encoded segment.

In one embodiment, the at least one first pixel may be adjacent to the to-be-encoded segment or adjacent to but spaced apart from the to-be-encoded segment.

In one embodiment, the data of the at least one first pixel may include the raw data of the at least one first pixel or the encoded data of the at least one first pixel.

In one embodiment, the at least one second pixel may be adjacent to the to-be-encoded segment or adjacent to but spaced apart from the to-be-encoded segment.

In one embodiment, the data of the at least one second pixel may include the raw data of the at least one second pixel or the encoded data of the at least one second pixel.

For example, the encoding unit 310 may be configured to determine a correlation between the to-be-encoded segment and the left-side data of the to-be-encoded segment according to the data of the to-be-encoded segment and the data of the at least one first pixel; determine a correlation between the to-be-encoded segment and the upper-side data of the to-be-encoded segment according to the data of the to-be-encoded segment and the data of the at least one second pixel; and determine the reference data of the to-be-encoded segment from the left-side data of the to-be-encoded segment and the upper-side data of the to-be-encoded segment according to the correlation between the to-be-encoded segment and the left-side data of the to-be-encoded segment and the correlation between the to-be-encoded segment and the upper-side data of the to-be-encoded segment.

In particular, the encoding unit 310 may be configured to determine one from the left-side data of the to-be-encoded segment and the upper-side data that has a larger correlation with the to-be-encoded segment as the reference data of the to-be-encoded segment.

In one embodiment, the encoding unit 310 may also be configured to add a fourth identifier to the encoded bitstream of the to-be-encoded segment. The fourth identifier may be used to indicate a location of the reference data of the to-be-encoded segment.

In one embodiment, the encoding unit 310 may also be configured to determine the quantization parameters of the corresponding to-be-encoded segment according to the reference data before using the quantization parameters of the to-be-encoded segment to perform the quantization process on the prediction results of the to-be-encoded segment.

In one embodiment, the encoding unit 310 may be configured to determine the complexity of the to-be-encoded segment according to the reference data of the to-be-encoded segment and the data in the to-be-encoded segment; and determine quantization parameters of the to-be-encoded segment according to the complexity of the to-be-encoded segment.

In one embodiment, the encoding unit 310 may be configured to determine a residual of each pixel in the to-be-encoded segment according to the reference data and the data in the to-be-encoded segment; and determine a complexity of the to-be-encoded segment according to the residual of each pixel in the to-be-encoded segment.

In one embodiment, the encoding unit 310 may be configured to determine the complexity of the rectangular region to which the to-be-encoded segment belongs according to the complexity of each segment in the rectangular region to which the to-be-encoded segment belongs; and determine the quantization parameters of the to-be-encoded segment by comparing the complexity of the to-be-encoded segment and the complexity of the rectangular region to which the to-be-encoded segment belongs.

For example, the encoding unit 310 may be configured to determine the reference data of the to-be-encoded segment from an available left-side data of the to-be-encoded segment and an available upper-side data if the to-be-encoded segment has the available left-side data and the available upper-side data.

Under such a condition, if the to-be-encoded segment has only the available left-side data or the upper-side data, the encoding unit 310 may determine the available left-side data or the available upper-side data of the to-be-encoded segment as the reference data of the to-be-encoded segment.

In one embodiment, if the to-be-encoded segment is adjacent to an upper boundary of the image and the to-be-encoded segment is adjacent to a left boundary of the image, the encoding unit 310 may also be configured to determine the predicted value of the first N pixels of the to-be-encoded segment as a preset value; and encode the remaining (T−N) pixels in the to-be-encoded segment according to the data of the first N pixels. T is the number of pixels included in the to-be-encoded segment, and 1≤N≤T.

In another embodiment, if the to-be-encoded segment is adjacent to an upper boundary of the image and the to-be-encoded segment is spaced apart from a left boundary of the image, the encoding unit 310 may also be configured to encode the pixels in the to-be-encoded segment according to the left side data of the to-be-encoded segment.

In one embodiment, if the to-be-encoded segment is spaced apart from an upper boundary of the image and the to-be-encoded segment is adjacent to a left boundary of the image, the encoding unit 310 may also be configured to encode the pixels in the to-be-encoded segment according to the upper side data of the to-be-encoded segment.

In one embodiment, if the to-be-encoded segment is adjacent to an upper boundary of a rectangular region to which the to-be-encoded segment belongs, and the to-be-encoded segment is adjacent to a left boundary of the rectangular region to which the to-be-encoded belongs, the encoding unit 310 may also be configured to determine a predicted value of the first N pixels in the to-be-encoded segment as a preset value; and encode the remaining (T−N) pixels in the to-be-encoded segment according to the data of the first N pixels. T is the number of pixels included in the to-be-encoded segment; and 1≤N≤T.

In one embodiment, if the to-be-encoded segment is adjacent to an upper boundary of a rectangular region to which the to-be-encoded segment belongs, and the to-be-encoded segment is spaced apart from a left boundary of the rectangular region to which the to-be-encoded segment belongs, the encoding unit 310 may also be configured to perform an encoding process on the pixels in the to-be-encoded segment according to the left-side data of the to-be-encoded segment.

In one embodiment, if the to-be-encoded segment is spaced apart from the upper boundary of the rectangular region to which the to-be-encoded segment belongs, and the to-be-encoded segment is adjacent to the left boundary of the rectangular region to which the to-be-encoded segment belongs, the encoding unit 310 may also be configured to perform an encoding process on the pixels in the to-be-encoded segment according to the upper-side data of the to-be-encoded segment.

In one embodiment, if the to-be-encoded segment is adjacent to an upper boundary of the sub-image to which the to-be-encoded segment belongs and the to-be-encoded segment is adjacent to a left boundary of the sub-image to which the to-be-encoded segment belongs, the encoding unit 310 may also be configured to determine a predicted value of the first N pixels in the to-be-encoded segment as a preset value, and perform an encoding process on the remaining (T−N) pixels in the to-be-encoded segment according to the data of the first N pixel points. T is the number of pixels included in the to-be-encoded segment, and 1≤N≤T.

In one embodiment, if the to-be-encoded segment is adjacent to an upper boundary of a sub-image to which the to-be-encoded segment belongs and the to-be-encoded segment is spaced apart from a left boundary of the sub-image to which the to-be-encoded segment belongs, the encoding unit 310 may also configured to perform an encoding process on the pixels in the to-be-encoded segment according to the left-side data of the to-be-encoded segment.

In one embodiment, if the to-be-encoded segment is spaced apart from an upper boundary of the sub-image to which the to-be-encoded segment belongs, and the to-be-encoded segment is adjacent to a left boundary of the sub-image to which the to-be-encoded segment belongs, an encoding process may be performed on the pixels in the to-be-encoded segment according to the upper-side data of the to-be-encoded segment.

In one embodiment, if the to-be-encoded segment is adjacent to an upper boundary and a left boundary of the sub-image to which the to-be-encoded segment belongs and the to-be-encoded segment is spaced apart from an upper boundary of the image, the encoding unit 310 may also be configured to encode the pixels in the to-be-encoded segment according to the upper-side data of the to-be-encoded segment.

In one embodiment, if the to-be-encoded segment is adjacent to an upper boundary and a left boundary of the sub-image to which the to-be-encoded segment belongs, and the to-be-encoded segment is spaced apart from a left boundary of the image, the encoding unit 310 may also be configured to encode the pixels in the to-be-encoded segment according to the left-side data of the to-be-encoded segment.

In one embodiment, each M adjacent pixels in the to-be-encoded segment may correspond to a same reference pixel. The reference data of the to-be-encoded segment may include the data of the reference pixel, and M≥1.

It should be understood that the above description of the encoding apparatus 300 is merely exemplary. In some embodiments, the encoding apparatus 300 may not include the above one or more modules, and the number of the modules included in the encoding apparatus 300 is not limited by the present disclosure.

It should also be understood that the encoding apparatus 300 herein is embodied in the form of a functional module. In some embodiments, those skilled in the art may understand that the encoding apparatus 300 may be specifically the execution body of the encoding method in the previous embodiments, and the encoding apparatus 300 may be used to perform various processes and/or steps in the previous embodiments.

FIG. 4 illustrates an exemplary decoding apparatus 400 consistent with various disclosed embodiments of the present disclosure. As shown in FIG. 4, the decoding apparatus 400 may include a decoding unit 410. The decoding unit 410 may be configured to perform a decoding processing on a first rectangular region in an image according to the encoded bitstream of the image. The image may include at least one rectangular region; and each rectangular region may include at least one pixel.

The decoding apparatus 400 may also include a boundary processing unit 420. The boundary processing unit 420 may be configured to determine the decoded data of at least one un-decoded pixel in the first rectangular region according to the decoded data of the at least one decoded pixel in the image if the encoded bitstream includes a first identifier. The first identifier may be used to identify an end of the encoding of the first rectangular region and that the first rectangular region may include at least one un-decoded pixel.

In particular, in one embodiment, the boundary processing unit 420 may be configured to determine a reference pixel of each of the at least one un-decoded pixel in the first rectangular region from the at least one decoded pixel of the image; and determine the decoding data (or decoded data) of each of the at least one un-decoded pixel as the decoding data (or decoded data) of the reference pixel of each pixel.

In one embodiment, the boundary processing unit 420 may be configured to divide the at least one un-decoded pixel into N groups of pixels; and determine a reference pixel of the j-th group of pixels of the N groups of pixels from the at least one decoded pixel of the image. Each group of pixels may include at least one pixel of the at least one un-decoded pixel. N is an integer greater than or equal to 1; and 1≤i≤N.

In one embodiment, the boundary processing unit 420 may be configured to obtain a second identifier from the encoded bit stream of the image; and determine a reference pixel of each of the j-th group of pixels according to the second identifier. The second identifier may be used to indicate a location of a reference pixel of the j-th group of pixels.

In one embodiment, the reference pixel of the j-th group of pixels may be located at the left side of the j-th group of pixels and may be the last encoded pixel of the first rectangular region. In another embodiment, the reference pixel of the j-th group of pixels may be spaced apart from the last encoded pixel by at least one pixel.

In one embodiment, the boundary processing unit 420 may be configured to divide the at least one un-decoded pixel into N groups of pixels according to the number of the at least one un-decoded pixel. The number of un-decoded pixels included in the first N−1 groups of pixels of the N groups of pixels may be the same.

In one embodiment, N is equal to 2. Correspondingly, the boundary processing unit 420 may be configured to determine the first P pixels in the at least one un-decoded pixel as the first group of pixel; and determine the remaining un-decoded pixels among the at least one un-decoded pixel other than the first group of pixels as the second group of pixels. P may be a preset value greater than or equal to 1.

In one embodiment, the j-th group of pixels may be the first group of pixels. Under such a condition, the boundary processing unit 420 may be configured to obtain at least one third identifier from the encoded bitstream of the image and determine a reference pixel of each pixel according to the third identifier corresponding to each pixel of the second group of pixels. The at least one third identifier may correspond to the at least one pixel of the second group of pixels, and each third identifier of the at least one third identifier may be used to indicate a location of the reference pixel of the corresponding pixel.

In one embodiment, the decoding unit 410 may be configured to perform an entropy decoding process on the to-be-decoded segment of the first rectangular region to obtain a quantization parameter of the to-be-decoded segment; perform an inverse quantization process on the to-be-decoded segment according to the quantization parameters of the to-be-decoded segment to obtain residual data of the to-be-decoded segment; and perform an inverse prediction process on the residual data of the to-be-decoded segment according to the reference data of the to-be-decoded segment to obtain a decoding result of the to-be-decoded segment. The first rectangular region may include at least one segment; and each segment may include at least one pixel.

In one embodiment, the decoding unit 410 may be configured to obtain a fourth identifier corresponding to the to-be-decoded segment; and determine the reference data of the to-be-decoded segment as the upper-side data or the left-side data of the to-be-decoded segment according to the fourth identifier corresponding to the to-be-decoded segment; and decode the to-be-decoded segment according to the reference data of the to-be-decoded segment. The fourth identifier may be used to identify a location of the reference data of the to-be-decoded segment. The left-side data of the to-be-decoded segment may include the data of at least one first pixel on the left side of the to-be-decoded segment. The upper-side data of the to-be-decoded segment may include the data of at least one second pixel located above the to-be-decoded segment.

It should be understood that the decoding apparatus 400 herein is embodied in the form of a functional module. In some embodiments, those skilled in the art may understand that the decoding apparatus 400 may be the execution body of the decoding method in the previous embodiments, and the decoding apparatus 400 may be used to perform various processes and/or steps in the previous method embodiments.

It should also be understood that in the embodiments of the present disclosure, the term “unit” may refer to an application specific integrated circuit (ASIC), an electronic circuit, a processor for executing one or more software or firmware programs (e.g., shared processor, proprietary processor or group processor, etc.) and memory, merge logic, and/or other suitable components that support the described functionality.

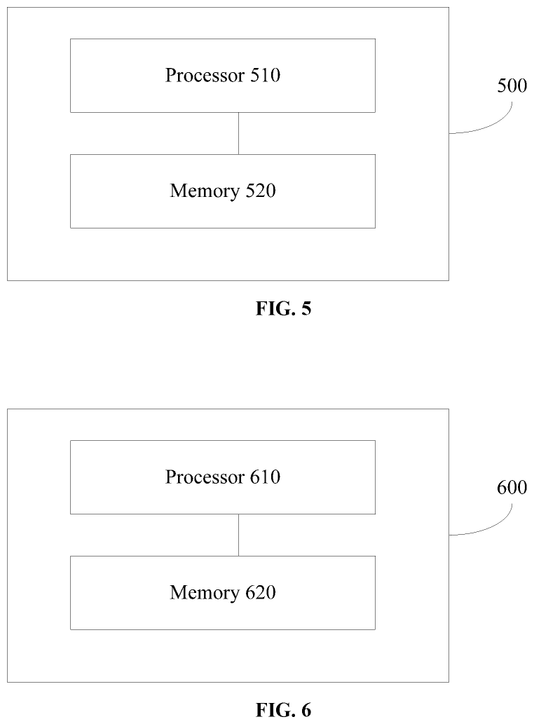

FIG. 5 illustrates another exemplary encoding apparatus 500 consistent with various disclosed embodiments of the present disclosure. As shown in FIG. 5, the encoding apparatus 500 may include a processor 510 and a memory 520. The memory 520 may be configured to store instructions; and the processor 510 may be configured to execute the instructions stored in the memory 520.

The execution of the instructions stored in the memory 520 may cause the processor 510 to execute the following steps.

First, an encoding process may be performed on the pixel(s) in a first rectangular region of an image. The image may include at least one rectangular region. Each rectangular region may include at least one pixel.

Then, if the total number of encoded bits Bi used by the first i encoded pixels in the first rectangular region is less than or equal to the maximum bit number Bₘₐₓ of allowable encoded bits of the first rectangular region, and the sum of the number of encoded bits bi+1 used by the (i+1)-th pixels the first rectangular region and Bi is greater than Bₘₐₓ, the encoded data of the at least one un-encoded pixel in the first rectangular region may be determined according to the encoded data of the at least one encoded pixel in the image. The at least one un-encoded pixel may include the (i+1)-th pixel, and 1≤I≤T−1. T is the total number of pixels included in the first rectangular region.

Then, a first identifier may be added to the encoded bitstream of the first rectangular region. The first identifier may identify the end of the encoding process of the first rectangular region and identify that the first rectangular region may have at least one un-encoded pixel.

In some embodiments, those skilled in the art may understand that the encoding apparatus 500 may be the encoding apparatus in the previous embodiments, and the encoding apparatus 500 may be used to perform various processes and/or steps in the previous method embodiments.

FIG. 6 illustrates another exemplary decoding apparatus 600 consistent with various disclosed embodiments of the present disclosure. As shown in FIG. 6, the decoding apparatus 600 may include a processor 610 and a memory 620. The memory 620 may be configured to store instructions, and the processor 610 may be configured to execute the instruction stored in the memory 620. The execution of the instructions stored in the memory 620 may cause the processor 610 to do following steps.

First, a decoding process may be performed on the first rectangular region (s) in the image according to the encoded bit stream of the image. The image may include at least one rectangular region; and each rectangular region may include at least one pixel.

Then, the decoded data of at least one un-decoded pixel in the first rectangular region may be determined according to the decoded data of at least one decoded pixel in the image if the encoded bitstream includes a first identifier. The first identifier may be used to identify the end of the encoding process of the first rectangular region and identify that the first rectangular region may have at least one un-encoded pixel.

In some embodiments, those skilled in the art may understand that the decoding apparatus 600 may be the decoding apparatus in the previous embodiments, and the decoding apparatus 600 may be used to perform various processes and/or steps in the previous method embodiments.

It should be understood that, in one embodiment of the present disclosure, the processor may be a central processing unit (CPU), and the processor may also be other general-purpose processors, digital signal processors (DSPs), and application specific integrated circuits (ASIC), field programmable gate array (FPGA) or other programmable logic devices, discrete gate or transistor logic devices, and discrete hardware components, etc. The general-purpose processor may be a microprocessor or any conventional processor, etc.

The memory may include read-only memory and random-access memory and may be used to provide instructions and data to the processor. A portion of the memory may also include a non-volatile random-access memory. For example, the memory may also store information of the device type. The processor may be used to execute instructions stored in the memory. When the processor executes the instructions, the processor may perform the steps of the previous embodiments corresponding to the terminal devices.

In the implementation process, each step of the previous described method may be completed by an integrated logic circuit of hardware in a processor or an instruction in a form of software. The steps of the method disclosed in the embodiments of the present disclosure may be directly implemented by a hardware processor or may be performed by a combination of hardware and software modules in the processor. The software module may be located in a conventional storage medium such as random-access memory, flash memory, read only memory, programmable read only memory or electrically erasable programmable memory, and/or registers, etc. The storage medium may locate in the memory, and the processor may execute instructions in the memory, in combination with the hardware, the above steps may be executed and finished.

It should be understood that the above description of the embodiments of the present disclosure is emphasized on the differences between the various embodiments, and the same or similar aspects that are not mentioned may be referred to each other.

Furthermore, the terms “system” and “network” may be used interchangeably herein. The term “and/or” in the context may be merely an association describing the associated objects, indicating that there may be three relationships, for example, A and/or B, which may indicate that A exists separately, and both A and B exist, B exists. In addition, the character “/” in this article generally indicates that the contextual object is an “or” relationship.

Those of ordinary skill in the art will appreciate that the elements and algorithm steps of the various examples described in connection with the embodiments disclosed herein may be implemented in electronic hardware or a combination of computer software and electronic hardware. Whether these functions are performed in hardware or software depends on the specific application and design constraints of the solution. A person skilled in the art may use different methods to implement the described functions for each particular application, but such implementation should not be considered to be beyond the scope of the present disclosure.

A person skilled in the art may clearly understand that for the convenience and brevity of the description, the specific working process of the system, the device and the unit described above may refer to the corresponding process in the previous method embodiments, and details are not described herein again.

In the several embodiments provided by the present disclosure, it should be understood that the disclosed systems, apparatus, devices, and methods may be implemented in other manners. For example, the apparatus embodiments described above are merely illustrative. For example, the division of the unit is only a logical function division. In an actual implementation, there may be another division manner. For example, multiple units or components may be combined or may be integrated into another system, or some features may be ignored or not executed. In addition, the mutual coupling or direct coupling or communication connection shown or discussed may be an indirect coupling or communication connection through some interfaces, devices or units, and may be in an electrical, mechanical or other form.

The units described as separate components may or may not be physically separated, and the components displayed as units may or may not be physical units, that is, may be located in one place, or may be distributed to multiple networks. Some of or all the units may be selected according to actual needs to achieve the purpose of the solution of the embodiment.

In addition, each functional unit in each embodiment of the present disclosure may be integrated into one processing unit, or each unit may exist physically separately, or two or more units may be integrated into one unit.

For the above embodiments, they may be implemented in whole or in part by software, hardware, firmware, or any combination thereof. When implemented in software, it may be implemented in whole or in part in the form of a computer program product. The computer program product includes one or more computer instructions. When the computer program instructions are loaded and executed on a computer, the processes or functions described in accordance with embodiments of the present disclosure are generated in whole or in part. The computer may be a general-purpose computer, a special-purpose computer, a computer network, or other programmable device. The computer instructions may be stored in a computer readable storage medium or transferred from one computer readable storage medium to another computer readable storage medium. For example, the computer instructions may be from a website site, computer, server or data center; and may be transferred to another website site, computer, server, or data center by wire (e.g., coaxial cable, fiber optic, or digital subscriber line (DSL)), or wireless (e.g., infrared, wireless, or microwave, etc.). The computer readable storage medium may be any available media that can be accessed by a computer or a data storage device, such as a server, or data center, etc., that includes one or more available media. The usable medium may be a magnetic medium (e.g., a floppy disk, a hard disk, or a magnetic tape), an optical medium (e.g., a DVD), or a semiconductor medium (e.g., a solid-state disk (SSD)), etc.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An encoding method, comprising:
performing an encoding process on at least one pixel of a first rectangular region of an image, wherein the image includes at least one rectangular region, the at least one rectangular region includes the first rectangular region, and each of the at least one rectangular region includes at least one pixel;
if a total bit number Bᵢ of encoded bits used by first i encoded pixels in the first rectangular region is smaller than or equal to a maximum bit number Bₘₐₓ of allowable encoded bits in the first rectangular region and a sum of the total bit number Bᵢ and a bit number bᵢ₊₁ of encoded bits for use by an (i+1)-th pixel in the first rectangular region is greater than the maximum bit number Bₘₐₓ, determining, according to encoded data of at least one encoded pixel in the image, encoded data of at least one un-encoded pixel in the first rectangular region, wherein the at least one un-encoded pixel includes the (i+1)-th pixel, 1≤i≤T−1, and T is a total number of pixels included in the first rectangular region; and
adding a first identifier on an encoded bitstream of the first rectangular region, wherein the first identifier is configured to identify an end of the encoding process of the first rectangular region and identify that the first rectangular region includes the at least one un-encoded pixel.

2. The method of claim 1, wherein determining the encoded data of the at least one un-encoded pixel in the first rectangular region according to the encoded data of the at least one encoded pixel in the image comprises:
determining, from the at least one encoded pixel in the image, a reference pixel of each pixel of the at least one un-encoded pixel; and
determining the encoded data of each pixel of the at least one un-encoded pixel as encoded data of the reference pixel of each pixel of the at least one un-encoded pixel.

3. The method of claim 2, wherein:
the reference pixel of each pixel of the at least one un-encoded pixel is located at a left side or on an upper side of each pixel; and/or
the reference pixel of each pixel of the at least one un-encoded pixel and each pixel are located in a same rectangular region or different rectangular regions.

4. The method of claim 2, wherein determining the reference pixel of each pixel of the at least one un-encoded pixel comprises:
dividing the at least one un-encoded pixel into N groups of pixels, wherein each group of pixels includes at least one pixel of the at least one un-encoded pixel and N is an integer greater than or equal to 1; and
determining, from the at least one encoded pixel in the image, a reference pixel of a j-th group of pixels in the N groups of pixels, wherein 1≤i≤N.

5. The method of claim 4, wherein determining the reference pixel of the j-th group of pixels in the N groups of pixels comprises:
according to raw data of the j-th group of pixels, determining the reference pixel of the j-th group of pixels from a first encoded pixel at a left side of the j-th group of pixels and at least one second encoded pixel on an upper side of the j-th group of pixels.

6. The method of claim 5, wherein according to raw data of the j-th group of pixels, determining the reference pixel of the j-th group of pixels from the first encoded pixel at the left side of the j-th group of pixels and at least one second encoded pixel on the upper side of the j-th group of pixels comprises:
determining a correlation between each pixel and the first encoded pixel according to the raw data of each pixel of the j-th group of pixels;
determining a correlation between each pixel and the second encoded pixel on the upper side of each pixel according to the raw data of each pixel of the j-th group of pixels; and
determining one of the first encoded pixel and the at least one second encoded pixel as the reference pixel of the j-th group of pixels according to the correlation between each pixel and the first encoded pixel of the j-th group of pixels and the correlation between each pixel and the second encoded pixel on the upper side of each pixel of the j-the group of pixels.

7. The method of claim 6, wherein at one of the following conditions is satisfied:
the first encoded pixel is a last pixel of the first i encoded pixels or the first encoded pixel is adjacent to or spaced apart from the last pixel with at least one pixel; and
each pixel of the j-th group of pixels is adjacent to or spaced apart from the second encoded pixel located above each pixel of the j-group of pixels with at least one pixel.

8. The method of claim 4, further comprising:
adding a second identifier on the encoded bitstream in the first rectangular region, wherein the second identifier is configured to indicate a location of the reference pixel of the j-th group of pixels.

9. The method of claim 4, wherein dividing the at least one un-encoded pixel into the N groups of pixels comprises:
according to a quantity of the at least one un-encoded pixel, dividing the at least one un-encoded pixel into the N groups of pixels, wherein a quantity of un-encoded pixels included in each of first N−1 groups of pixels of the N groups of pixels is same.

10. The method of claim 4, wherein:
N is equal to 2; and
the at least one un-encoded pixel is divided into to two groups of pixels,
wherein:
first P pixels of the at least one un-encoded pixel are determined as a first group of pixels, P being a predetermined value greater than or equal to 1; and
remaining pixels of the at least one un-encoded pixel other than the first group pixels are determined as a second group of pixels.

11. The method of claim 10, wherein determining the reference pixel of each pixel of the at least one un-encoded pixel further comprises:
according to raw data of each pixel of the first group of pixel, determining, from encoded pixel at a left side of each pixel, reference pixel of each pixel.

12. The method of claim 11, further comprising:
adding at least one third identifier on an encoded bitstream in the first rectangular region, wherein:
the at least one third identifier corresponds to at least one pixel of the first group of pixel; and
each third identifier of the at least one third identifier is used to identify a location of the reference pixel of the corresponding pixel.

13. A decoding method comprising:
according to an encoded bitstream of an image, performing a decoding process on a first rectangular region of the image, wherein the image includes at least one rectangular region, the at least one rectangular region includes the first rectangular region and each rectangular region includes at least one pixel; and
according to decoded data of at least one decoded pixel in the image, determining, if the encoded bitstream image includes a first identifier, decoded data of at least one un-decoded pixel in the first rectangular region, wherein the first identifier is used to indicate the end of the decoding process of the first rectangular region and indicate that the first region includes at least one un-decoded pixel.

14. The method of claim 13, wherein according to the decoded data of the at least one decoded pixel in the image, determining the decoded data of the at least one un-decoded pixel in the first rectangular region comprises:
determining a reference pixel of each pixel of the at least one un-decoded pixel in the first rectangular region from the decoded data of the at least one decoded pixel in the image; and
determining decoded data of each pixel of the at least one un-decoded pixel as decoded data of the reference pixel of each pixel.

15. The method of claim 14, wherein:
the reference pixel of each pixel of the at least one un-encoded pixel is located at a left side or on an upper side of each pixel; and/or
the reference pixel of each pixel of the at least one un-encoded pixel and each pixel are located in a same rectangular region or different rectangular regions.

16. The method of claim 15, wherein determining, from the at least one decoded pixel in the image, the reference pixel of each pixel of the at least one un-decoded pixel in the first rectangular region comprises:
dividing the at least one un-decoded pixel into N groups of pixels, wherein each group of pixels include at least one pixel of the at least one un-decoded pixel and N is an integer greater than or equal to 1; and
determining, from the at least one decoded pixel in the image, a reference pixel of a j-th group of pixels in the N groups of pixels wherein 1≤i≤N.

17. The method of claim 16, wherein determining, from the at least one decoded pixel in the image, the reference pixel of each pixel of the j-th group pixels comprises:
obtaining a second identifier from the encoded bitstream of the image, wherein the second identifier is used to identify a location of the reference pixel of the j-th group of pixels; and
according to the second identifier, determining the reference pixel of each pixel of the j-th group of pixels.

18. The method of claim 17, wherein at one of the following conditions is satisfied:
the reference pixel of the j-th group of pixels is located at a left side of the j-th group of pixels and is a last encoded of the rectangular; or
the reference pixel of the j-th group of pixels is spaced apart from the last encoded pixel with at least one pixel; and
the reference pixel of each pixel of the j-th group of pixels is located above each pixel of the j-group of pixels and is adjacent to each pixel or spaced apart from each pixel with at least one pixel.

19. The method of claim 18, wherein dividing the at least one un-decoded pixel into the N groups of pixels comprises:
according to a quantity of the at least one un-decoded pixel, dividing the at least one un-decoded pixel into the N groups of pixels, wherein a quantity of un-encoded pixels included in each of first N−1 groups of pixels of the N groups of pixels is same.

20. The method of claim 19, wherein:
N is equal to 2; and
the at least one un-decoded pixel is divided into to two groups of pixels,
wherein:
first P pixels of the at least one un-decoded pixel are determined as a first group of pixels, P being a predetermined value greater than or equal to 1; and
remaining pixels of the at least one un-decoded pixel other than the first group pixels are determined as a second group of pixels.
